(19) United States
(12) Patent Application Publication
(10) Pub. No.: US 2012/0067837 A1
(43) Pub. Date: Mar. 22, 2012

(54) SUSPENSION DEVICE

(76) Inventors: Guodong He, Dongguan (CN); Yunyou Long, Dongguan (CN); Guofeng Yang, Dongguan (CN)

(21) Appl. No.: 12/910,872

(22) Filed: Oct. 25, 2010

(30) Foreign Application Priority Data
Sep. 17, 2010 (CN) 201020546266.3

(51) Int. Cl. F16M 13/02

(52) U.S. Cl. 211/123; 211/1

(57) ABSTRACT

A suspension device includes a suspender, a suspension housing, and a positioning assembly, the suspender being mounted on the suspension housing, the positioning assembly including a suspension substrate, an elastic member, a button and wall-in screws, a first locking arm and a second locking arm being respectively extended from two ends of the suspension substrate, an assemble bore being formed on the second locking arm, a blind hole being formed on the button, the upper end of the elastic member being coupled to the suspension substrate and being arranged between the first locking arm and the second locking arm, the lower end of the elastic member being snapped into the blind hole, a socket and a through hole being formed on the suspension housing, the first locking arm being engaged with the socket, the button being successively gone through the assemble bore and the through hole.

### FIELD OF THE INVENTION

The present invention relates to a suspension device, more particularly, to a suspension device characteristic of simple structure, large holding power, facilitated assembling and disassembling.

### BACKGROUND OF THE INVENTION

In daily life, people usually hang the living goods on the wall, e.g. hanging the towel beside the washbasin; hanging the clothes and the accessories beside the wardrobe; hang the photo frame and decorative painting, etc around the wall in the room.

Diverse suspenders exist in the market currently, and people usually use one kind of suspender to hang up the living goods, this suspender could be fixed on the wall as long as it is pasted with one glue layer. Although the suspender structure is simple, it could achieve rapid assembling and facilitate using. However, it exists a insurmountable problem, which is as the suspender hanging the goods for a long time, the stickiness of the glue is weaker, and the holding power of the suspender is decreased, after a period of time, though the suspender could hang light goods, e.g. accessories, nevertheless, the supporting power is too small to hold the heavier good, e.g. coat or photo frame etc, and the suspender is probable to divorced from wall to result in accident when the suspender is hang up for a long time. Moreover, the suspender will leave some trace of the glue behind, so that the appearance will be greatly influenced.

In addition, there is another kind of suspender, which could be hang on the wall by pounding nail into the wall to fix the suspension substrate on the wall. Moreover, there is yet another kind of suspender assembly, and the suspension assembly includes suspender, suspension housing and assemble substrate, when the user assembling the suspension assemble, firstly, mount the suspender on the assemble substrate, then employ a long screw to go through the assemble substrate to reach the suspension housing, and connect to the suspension housing, lastly, fix the assemble substrate on the wall using wall-in screw or bolt. This kind of suspension assembly is characteristic of large holding power, sound construction and capable of hanging up large goods and the operation life is long; the screw head is exposed outside, which has effect on the appearance of the wall. Moreover, as people have larger and larger requirement as for the function of the suspender, people hope that one suspender has more functions, that is the suspender is not only the hook shape convenient for hanging clothes, but also the ring shape or rod shape convenient for hanging towel or other goods, hence, although the above suspender is characteristic of large holding power, it still could not meet the need of more functions as for people, and could not facilitate assembly and disassembly.

Consequently, a need has arisen for providing a suspension device characteristic of simple structure, large holding power, and facilitated assembling and disassembling.

### SUMMARY OF THE INVENTION

One objective of the present invention is to provide a suspension device, which includes a suspender, a suspension housing, and a positioning assembly, the suspender being mounted on the suspension housing, the positioning assembly including a suspension substrate, an elastic member, a button and wall-in screws, a first locking arm and a second locking arm being respectively extended from two ends of the suspension substrate, an assemble bore being formed on the second locking arm, a blind hole being formed on the button, the upper end of the elastic member being coupled to the suspension substrate and being arranged between the first locking arm and the second locking arm, the lower end of the elastic member being snapped into the blind hole, a socket and a through hole being formed on the suspension housing, and the socket and the through hole being respectively arranged to correspond to the first locking arm and the second locking arm, the first locking arm being engaged with the socket, the button being successively gone through the assemble bore and the through hole, the wall-in screws being mounted on the suspension substrate.

In comparison with the prior art, the suspension device of the present invention discloses that the suspension housing is hung on the wall by employing screws into the wall, concretely, the positioning assembly of the suspension device includes an elastic member and a button, when assembling the suspension device, one end of the elastic member is fixed on the suspension substrate, the other end of the elastic member is snapped into the button, and the suspension substrate is mounted on the suspension housing via the first locking arm, meanwhile, the button is successively gone through the second locking arm and the suspension housing to exposed outside, then the assembly is done. When disassembling the suspension device, the button is pushed to go through the suspension housing and the second locking arm successively to arranged within the suspension housing, then the suspension housing is facilitate to disassemble from the suspension substrate. When the user needs to change suspenders with different shapes, the previous suspender could be facilitated disassembling, and the new suspender could be mounted on the suspension substrate via the suspension housing. The suspension device of the present invention is mounted on the wall by employing the wall-in screw, so that the holding power of the suspension device is large, and the using life thereof is long. Moreover, match usage of the elastic member and the button enables the structure of the suspension device is simple, and facilitates assembling and disassembling. Preferably, according to the requirement of the user, the suspension device could change different suspenders without disassembling the suspension substrate, so the suspension device is characteristic of convenience and wider applicability.

Preferably, a fastener is arranged on and projected over the suspension substrate of the suspension device, and the upper end of the elastic member is fixed to connect to the fastener. The match usage of the fastener, the elastic member and the button facilitates the assembly and disassembly of the suspension device, so that the suspension device is characteristic of wider applicability and large holding power.

Preferably, the suspension device further comprises plugs, the wall-in screws are gone through the suspension substrate, to engage with the plugs. When the wall is cement wall, if the screw or the bolt is pounded into the cement wall directly, the suspension device is not fixed enough, hence, the plug is disclosed in the embodiment of the present invention, firstly the plug is pounded into the wall, then the wall-in screw is put into the plug so that the suspension device is fixed on the wall, long time usage and reliability of the suspension device is obtain according to this kind of fixing method.

Preferably, a recess is formed in the suspension housing of the suspension device, the socket is arranged within the recess of the suspension housing, the through hole is connected to the recess, a first guide rail is arranged beside the socket, a second guide rail is arranged beside the through hole, with the first locking arm connected to the first guide rail, and the second locking arm connected to the second guide rail. The first locking arm and the second locking arm are respectively connected to the first guide rail is and the second guide rails, whereby the suspension housing mounted on the suspension substrate firmly.

Optionally, the wall-in screw of the suspension device is self-tapping screw.

Preferably, the leading end of the suspension housing of the suspension device is equipped with a connection head, and a connection hole is formed on the connection head.

Preferably, according to the first embodiment of the present invention, the suspender of the suspension device is a suspension rod, two ends of the suspension rod are respectively engaged with the connection hole of the connection head. According to this embodiment, the arrangement of the suspension rod enables the suspension device configured to hang up the towel or the like.

Preferably, according to the second embodiment of the present invention, the suspender comprises an outside tube, an inner tube and a spring, two ends of the outside tube are respectively engaged with the connection holes of the connection heads, the spring and the inner tube are held within the outside tube, one end of the spring is engaged with the connection hole, the other end of the spring is engaged with one end of the inner tube, the other end of the inner tube is engaged with the connection hole. According to this embodiment, the arrangement of this suspension device enables the suspension device configured to hang up tissue, and the arrangement of the inner tube and the outside tube facilitate the change of the tissue.

Preferably, according to the third embodiment of the present invention, the suspender is a slinger, and the slinger is engaged with the connection hole of the connection head. According to this embodiment, the arrangement of slinger enables the suspension device configured to hang up hand towel or the like.

Preferably, according to the third embodiment of the present invention, the suspender comprises a screw and a hook, one end of the screw is connected to the hook, and the other end of the screw is connected to the suspension housing. According to this embodiment, the match arrangement of the hook and the screw enables the suspension device configured to hang up photo frame or other decorations, or clothes.

### BRIEF DESCRIPTION OF THE DRAWINGS

The present invention will become apparent from the following detailed description when taken in conjunction with the accompanying drawings, which are a part of this disclosure illustrating the embodiments of the present invention, as for the ordinary skilled in the art, other figures could be obtained according to these figures hereinafter, without any creative working.

FIG. 1 is a schematic illustration demonstrating the suspension device according to the first embodiment of the present invention;

FIG. 2 is an exploded enlarged illustration demonstrating the suspension housing and the positioning assembly according to the suspension device as shown in FIG. 1;

FIG. 3a is a schematic illustration demonstrating the suspension device as shown in FIG. 2 from one angle;

FIG. 3b is a schematic illustration demonstrating the suspension device as shown in FIG. 2 from another angle;

FIG. 3c is a schematic illustration demonstrating the suspension device as shown in FIG. 2 from yet another angle;

FIG. 4a is a schematic illustration demonstrating the suspension device according to the second embodiment of the present invention;

FIG. 4b is a schematic illustration demonstrating the suspension device as shown in FIG. 4a from another angle;

FIG. 5a is a schematic illustration demonstrating the suspension device according to the third embodiment of the present invention;

FIG. 5b is a schematic illustration demonstrating the suspension device as shown in FIG. 5a from another angle; and

FIG. 6 is a schematic illustration demonstrating the suspension device according to the fourth embodiment of the present invention.

### DETAILED DESCRIPTION OF ILLUSTRATED EMBODIMENTS

The present invention will now be clearly and completely described from the following detailed description when taken in conjunction with the accompanying drawings. Various preferred embodiments of the invention will now be described with reference to the figures, wherein like reference numerals designate similar parts throughout the various views. The present invention provides a suspension device, adapted for hanging up decorations, bath-room things or clothes, etc, which is characteristic of simple structure, large holding power, facilitated assembling and disassembling, and facilitates being changed into different suspenders according to the requirement of the users.

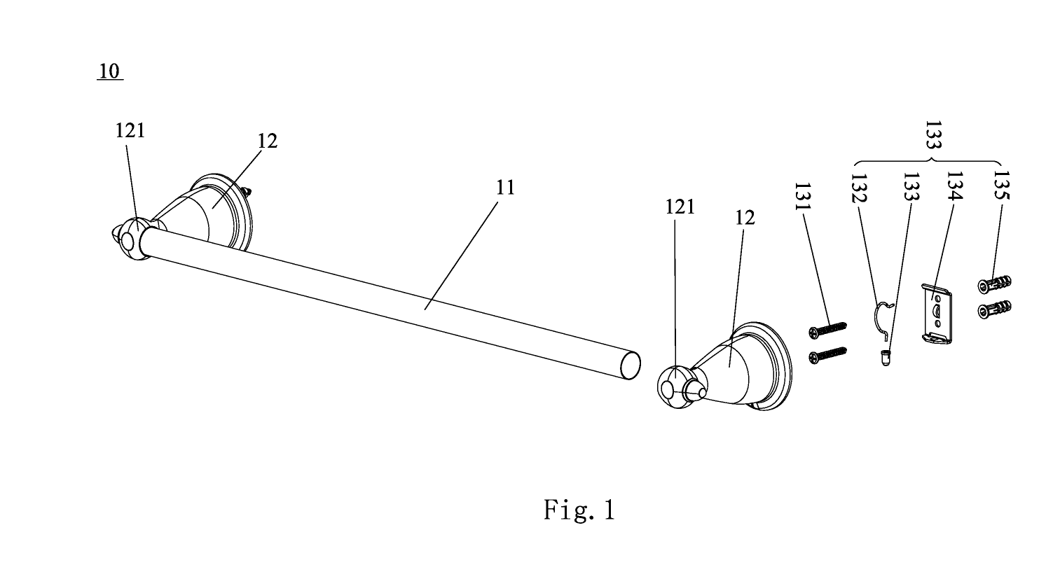

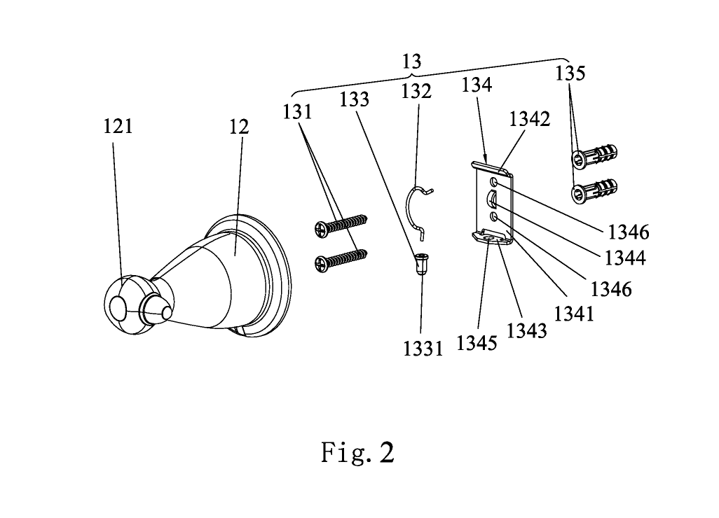

FIG. 1 is a schematic illustration demonstrating the suspension device according to the first embodiment of the present invention. Referring to FIGS. 1-3c, the suspension device 10 includes a suspender 11, a suspension housing 12 and a positioning assembly 13, the positioning assembly 13 includes wall-in screws 131, an elastic member 132, a button 133, a suspension substrate 134 and a plug 135. The suspender 11 is mounted on the suspension housing 12. The suspension substrate 134 includes suspension substrate body 1341, and two ends of the suspension substrate body 1341 are respectively extended to form a first locking arm 1342 and a second locking arm 1343. A fastener 1344 is arranged on and projected over the suspension substrate body 1341, as a arch bridge, the fastener 1344 is formed on the suspension substrate body 1341, and arranged between the first locking arm 1342 and the second locking arm 1343. A assemble bore 1345 is formed on the second locking arm 1343, an assemble bore 1345 is a through hole gone through the second locking arm 1343. A recess 123 is formed in the suspension housing 12, and the opening of the recess 123 is arranged on the tailing end of the suspension housing 12 and faced the suspension substrate 134. A socket 124 is arranged on the inner wall of the suspension housing 12, and the socket 124 is arranged in the recess 123. A through hole 125 is formed on the suspension housing 12 and arranged on the opposite side where the socket 124 arranged on, and the through hole 125 is connected to the outside via the recess 123. The socket 124 and the through hole 125 are respectively arranged to correspond to the first locking arm 1342 and the second locking arm 1343. Two first guide rails 126 are arranged on two sides of the socket 124, and two second guide rails 127 are arranged on two sides of the through hole 125. The first locking arm 1342 is connected to the first guide rails 126, and the second locking arm 1343 is connected to the second guide rails 127.

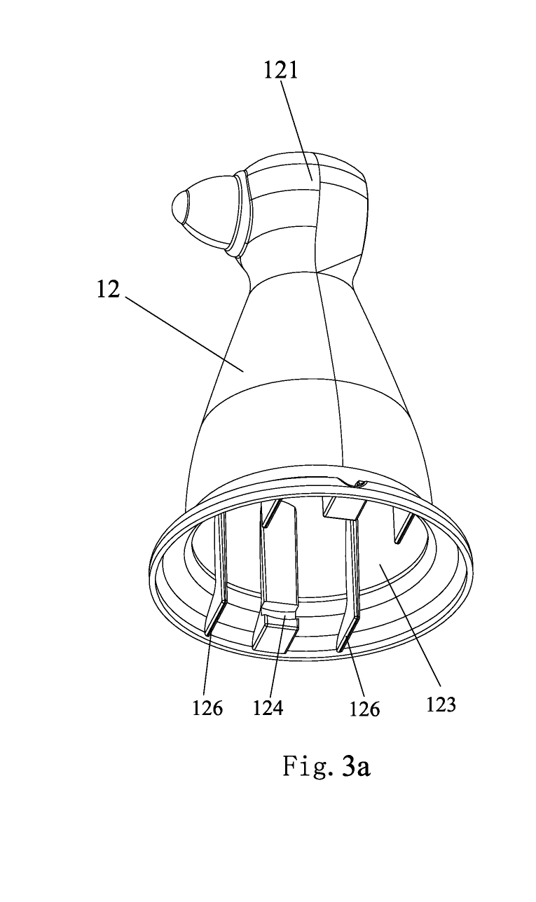

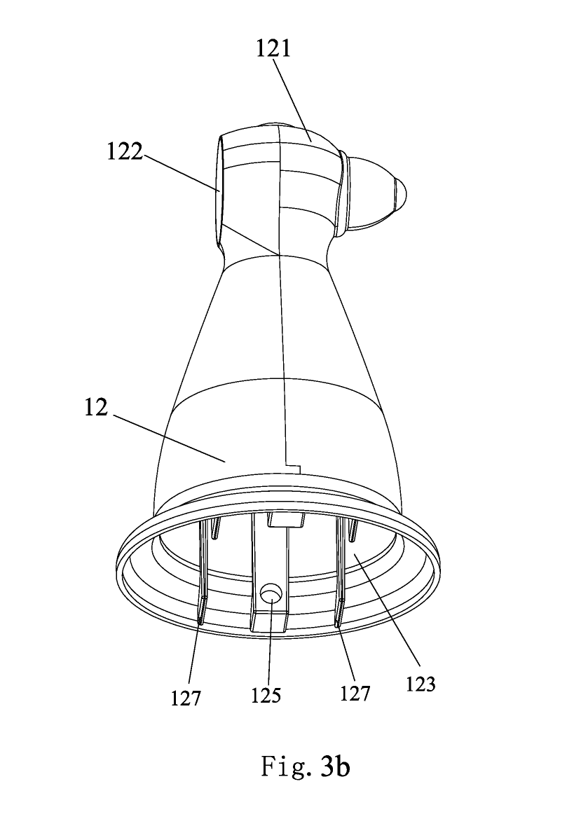

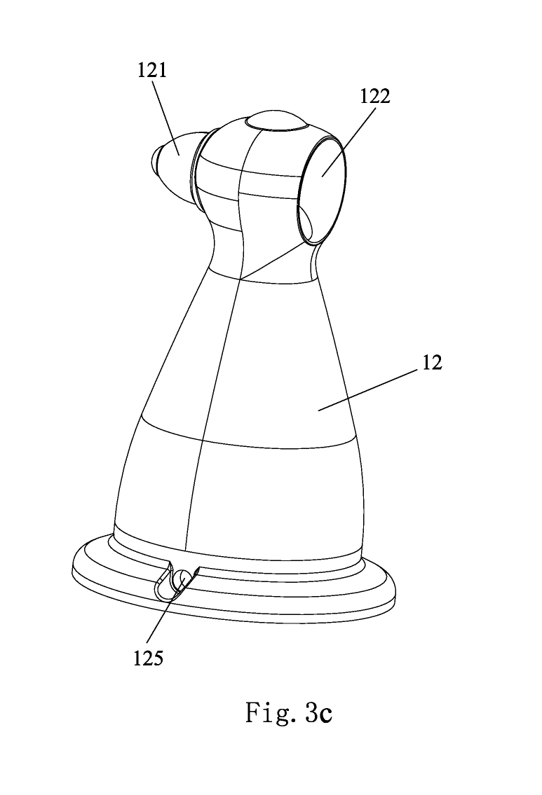

Referring to FIGS. 1-3c, two mounting holes 1346 are formed on the suspension substrate body 1341, which is adapted for mounting the wall-in screws 131 thereon. The plugs 135 are made of plastic, and the wall-in screws 131 are gone through the mounting holes 1346 of the suspension substrate 134 to mount in the plugs 135. As the wall is cement wall, if the wall-in screw or the bolt is pounded into the wall directly, the suspension device will not reliable enough, so the pugs 135 are employed in the present invention. Firstly, the plug 135 is pounded into the wall, and then the wall-in screw is turned into the plug 135 so the suspension device is mounted on the wall, whereby the suspension housing is mounted on the suspension substrate firmly, and the using life of the suspension device is long. Optionally, the wall-in screw 131 is self-tapping screw. According to another embodiment, the wall-in screw could be other type of the screw. Before the suspension device 10 is arranged on the wall, two holes are pounded on the wall, and the plugs 135 are pounded into the holes of the wall. The elastic member 132 is made of steel wire or other material. One end of the button 133 is equipped with a blind hole 1331. When assembling the suspension device 10 according to the present invention, firstly, one end of the elastic member 132 is snapped into the fastener 1344 of the suspension substrate 134, and the other end of the elastic member 132 is snapped into the blind hole 1331 of the button 133, and then the button 134 is gone through the assemble bore 1345. Secondly, the first locking arm 1342 of the suspension substrate 134 is slid between the first guide rails 126 of the suspension housing 12, and snapped to mount on the first guide rails 126, meanwhile, the first locking arm 1342 is snapped into the socket 124 of the suspension housing 12. In the same way, the second locking arm 1343 of the suspension substrate 134 is slid between the second guide rails 127 of the suspension housing 12, and snapped to mount on the second guide rails 127, meanwhile, under the elasticity of the elastic member 132, the button 133 is successively gone through the assemble bore 1345 of the second locking arm 1343 and the through hole 125 of the suspension housing 12. Referring to FIG. 3c, the button 133 would be gone through the through hole 125 and stopped on the position of the through hole 125, which enables partial button 133 expose outside of the suspension device 10. The first locking arm 1342 and the second locking arm 1343 are respectively connected to the first guide rails 126 and the second guide rails 127, whereby the suspension housing 12 is mounted on the suspension substrate 134 firmly. The match usage of the fastener 1344, the elastic member 132 and the button 133 achieves the quick assembling of the suspension device 10. When disassembling the suspension device 10, the button 133 is pressed to go through the outer wall of the suspension housing 12 and the assemble bore 1345 successively, so that the button 133 is arranged in the recess 123, then the suspension 134 is pulled outwards, so that the first locking arm 1342 is removed from the socket 124 and the first guide rails 126, meanwhile, the second locking arm 1343 is removed from the second guide rails 127, so as to achieve the rapid disassembling of the suspension device 10.

Referring to FIGS. 1-3c, the leading end of the suspension housing 12 is equipped with a connection head 121, and a connection hole 122 is formed on the connection head 121. According to the first embodiment of the present invention, the suspender 11 is a suspension rod, and two ends of the suspender 11 are respectively engaged with the connection holes 122 of the connection heads 121. According to this embodiment, the arrangement of the suspension rod enables the suspension device 10 configured to hang up the towel or the like.

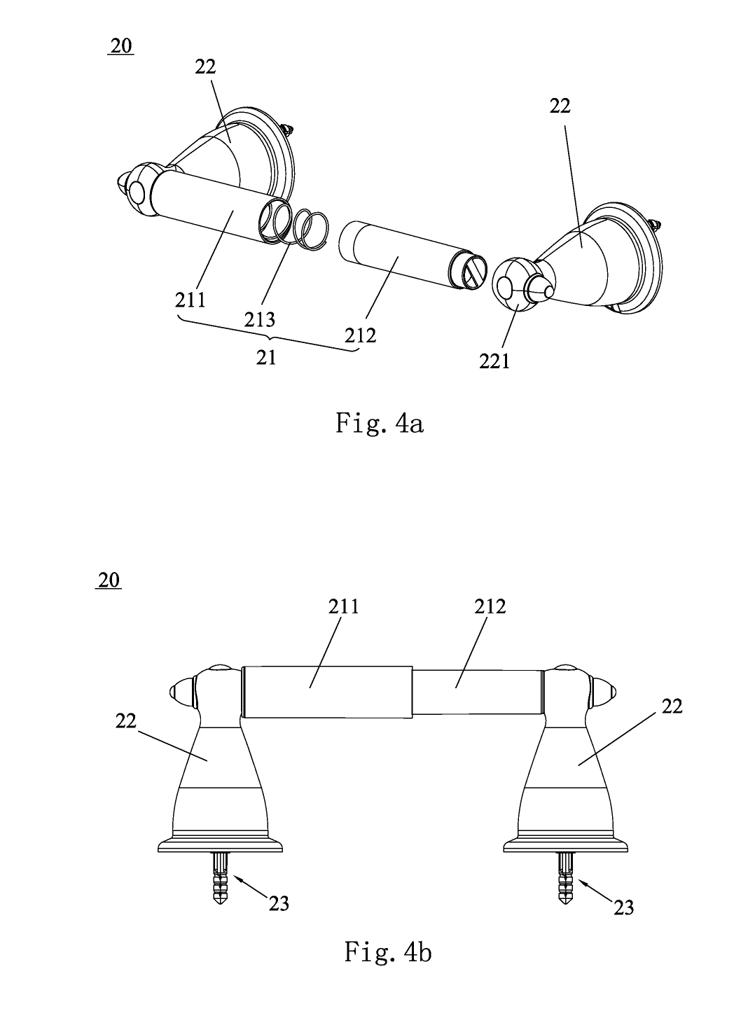

FIGS. 4a-4b demonstrate the suspension device according to the second embodiment of the present invention. Referring to FIGS. 4a-4b, the suspension device 20 includes a suspender 21, a suspension housing 22 and a positioning assembly 23. According to this embodiment, the suspender 21 includes an outside tube 211, an inner tube 212 and a spring 213, two ends of the outside tube 211 are respectively engaged with the connection holes (not shown) of the connection heads 221, the spring 213 and the inner tube 212 are held within the outside tube 211. One end of the spring 213 is engaged with the connection hole of the connection head 221, the other end of the spring 213 is engaged with one end of the inner tube 212, and the other end of the inner tube 212 is engaged with the connection hole of the connection head 221. According to this embodiment, except that the suspender 21 is different from the suspension rod according to the first embodiment of the suspension device, in conjugation with FIGS. 1-3c, the structure of the suspension housing 22 and the positioning assembly 23 is similar to that of the suspension housing 11 and the positioning assembly 13. The arrangement of this suspension device 21 according to the second embodiment enables the suspension device configured to hang up tissue, and the arrangement of the outside tube 211, the inner tube 212 and the spring 213 facilitate the change of the tissue by the user in accordance with their requirement at any moment.

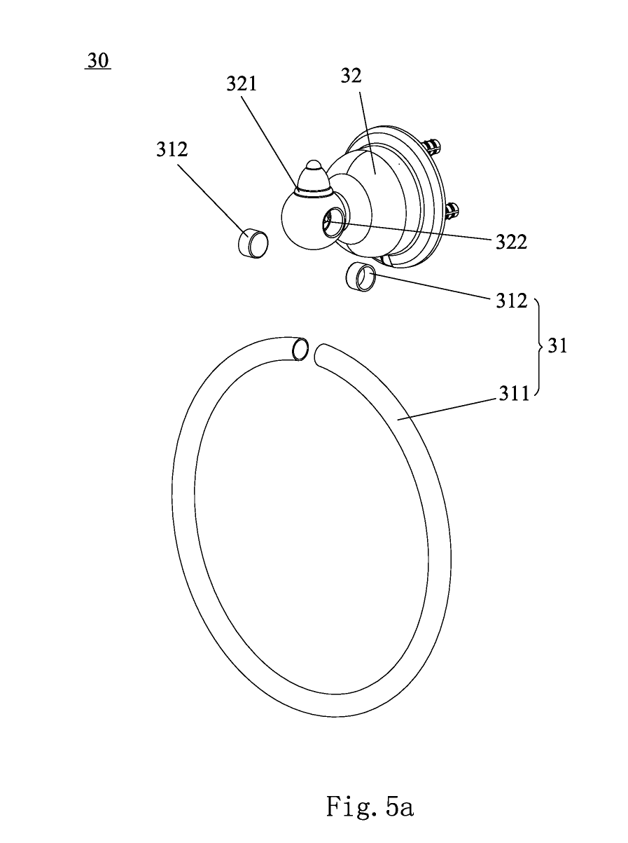

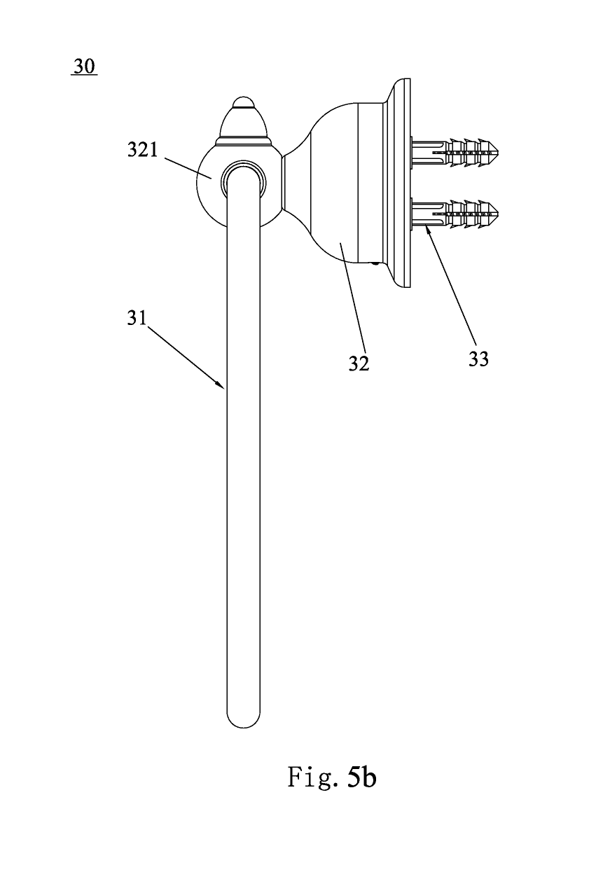

FIGS. 5a-5b demonstrate the suspension device according to the third embodiment of the present invention. Referring to FIGS. 5a-5b, the suspension device 30 includes a suspender 31, a suspension housing 32 and a positioning assembly 33. According to this embodiment, the suspender 31 includes a slinger 311 and two connectors 312, and the slinger 311 is detachably mounted on the connection head 321 through the connectors 312. According to this embodiment, the arrangement of slinger enables the suspension device configured to hang up hand towel or the like. In conjugation with FIGS. 1-3c, the structure of the positioning assembly 33 of the suspension device 30 is similar to that of the positioning assembly 13, and the connection head 321 is equipped with two connection holes 322 which is different from that of the suspension device 10, and the slinger 311 is engaged with the connection holes 322 of the connection head 321 through the connectors 312 detachably. According to this embodiment, the arrangement of slinger 311 enables the suspension device 30 configured to hang up hand towel or the like.

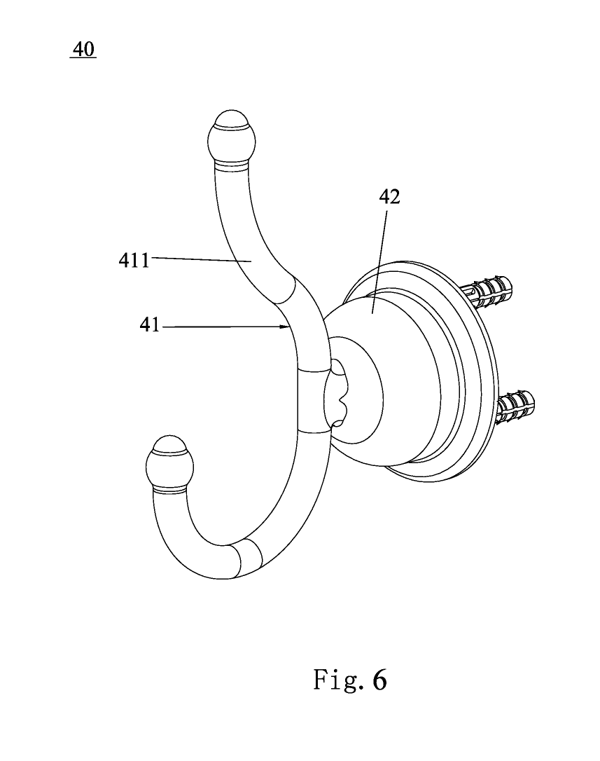

FIG. 6 demonstrates the suspension device according to the fourth embodiment of the present invention. Referring to FIG. 6, the suspension device 40 includes a suspender 41, a suspension housing 42 and a positioning assembly 43. According to the fourth embodiment of the present invention embodiment, the suspender 41 includes a screw (not shown) and a hook 411, one end of the screw is connected to the hook 411, and the other end of the screw is connected to the suspension housing 42. According to this embodiment, in conjugation with FIGS. 1-3c, the structure of the positioning assembly 43 of the suspension device 40 is similar to that of the positioning assembly 13, the match arrangement of the hook, the screw and the suspension housing 42 enables the suspension device configured to hang up photo frame or other decorations, or clothes.

The suspension device of the present invention discloses that the suspension housing is hung on the wall by employing screws into the wall, concretely, the positioning assembly of the suspension device includes an elastic member and a button, when assembling the suspension device, one end of the elastic member is fixed on the suspension substrate, the other end of the elastic member is snapped into the button, and the suspension substrate is mounted on the suspension housing via the first locking arm, meanwhile, the button is successively gone through the second locking arm and the suspension housing to exposed outside, then the assembly is done. When disassembling the suspension device, the button is pushed to go through the suspension housing and the second locking arm successively to arranged within the suspension housing, then the suspension housing is facilitate to disassemble from the suspension substrate. When the user needs to change suspenders with different shapes, the previous suspender could be facilitated disassembling, and the new suspender could be mounted on the suspension substrate via the suspension housing. The suspension device of the present invention is mounted on the wall by employing the wall-in screw, so that the holding power of the suspension device is large, and the using life thereof is long. Moreover, match usage of the elastic member and the button enables the structure of the suspension device is simple, and facilitates assembling and disassembling. Preferably, according to the requirement of the user, the suspension device could change different suspenders without disassembling the suspension substrate, so the suspension device is characteristic of convenience and wider applicability.

As indicated above, the invention has been described in connection with what are considered to be the most preferred embodiments, but it is not intended to limit the scope of protection of the present invention through the above description, and modifications and variations which are made according to the essence of the present invention are intended to be included within the scope of the present invention.

What is claimed is:

1. A suspension device, comprising a suspender, a suspension housing, and a positioning assembly, the suspender being mounted on the suspension housing, the positioning assembly including a suspension substrate, an elastic member, a button and wall-in screws, a first locking arm and a second locking arm being respectively extended from two ends of the suspension substrate, an assemble bore being formed on the second locking arm, a blind hole being formed on the button, the upper end of the elastic member being coupled to the suspension substrate and being arranged between the first locking arm and the second locking arm, the lower end of the elastic member being snapped into the blind hole, a socket and a through hole being formed on the suspension housing, and the socket and the through hole being respectively arranged to correspond to the first locking arm and the second locking arm, the first locking arm being engaged with the socket, the button being successively gone through the assemble bore and the through hole, the wall-in screws being mounted on the suspension substrate.

2. The suspension device as claimed in claim 1, wherein a fastener is arranged on and projected over the suspension substrate, and the upper end of the elastic member is fixed to connect to the fastener.

3. The suspension device as claimed in claim 1, wherein the suspension device further comprises plugs, the wall-in screws are gone through the suspension substrate, to engaged with the plugs.

4. The suspension device as claimed in claim 1, wherein a recess is formed in the suspension housing, the socket is arranged within the recess of the suspension housing, the through hole is connected to the recess, a first guide rail is arranged beside the socket, a second guide rail is arranged beside the through hole, with the first locking arm connected to the first guide rail, and the second locking arm connected to the second guide rail.

5. The suspension device as claimed in claim 1, wherein the wall-in screw is self-tapping screw.

6. The suspension device as claimed in claim 1, wherein the leading end of the suspension housing is equipped with a connection head, and a connection hole is formed on the connection head.

7. The suspension device as claimed in claim 6, wherein the suspender is a suspension rod, two end of the suspension rod are respectively engaged with the connection hole of the connection head.

8. The suspension device as claimed in claim 6, wherein the suspender comprises an outside tube, an inner tube and a spring, two ends of the outside tube are respectively engaged with the connection holes of the connection heads, the spring and the inner tube are held within the outside tube, one end of the spring is engaged with the connection hole, the other end of the spring is engaged with one end of the inner tube, the other end of the inner tube is engaged with the connection hole.

9. The suspension device as claimed in claim 6, wherein the suspender is a slinger, and the slinger is engaged with the connection hole of the connection head.

10. The suspension device as claimed in claim 1, wherein the suspender comprises a screw and a hook, one end of the screw is connected to the hook, and the other end of the screw is connected to the suspension housing.
